(19) United States
(12) Patent Application Publication
(10) Pub. No.: US 2006/0248019 A1
(43) Pub. Date: Nov. 2, 2006

(54) Method and system to detect fraud using voice data

(76) Inventor: Anthony Rajakumar, Menlo Park, CA (US)

Correspondence Address: HAHN AND MOODLEY, LLP, P.O. BOX 52050, MINNEAPOLIS, MN, 55402, US

(21) Appl. No.: 11/404,342

(22) Filed: Apr. 14, 2006

Related U.S. Application Data
(60) Provisional application No. 60/673,472, filed on Apr. 21, 2005.

(51) Int. Cl. G06Q 99/00

(52) U.S. Cl. 705/64

(57) ABSTRACT

According to one aspect of the invention there is provided a method, comprising (a) maintaining a collection of voice signatures, at least a subset of which is organized to form a list of voice signatures, each belonging to a disqualified candidate; (b) obtaining a voice sample for a candidate; (c) comparing the voice sample with the voice signatures in the list; and (d) if the voice sample matches a signature in the list, then returning a status of disqualified for the candidate. According to another aspect of the invention there is provided a method, comprising receiving a request form a merchant to perform a fraud detection operation in connection with a credit card transaction by a consumer; responsive to the request, collecting a voice sample from the consumer; comparing the collected voice sample with voice signatures of known fraudsters; and notifying the merchant of a result of the comparing.

### RELATED APPLICATIONS

This application claims the benefit of priority to U.S. 60/673,472, filed Apr. 21, 2005, the entire specification of which is hereby incorporated by reference.

### FIELD

Embodiments of the invention relate to a method and system to detect fraud such as credit card fraud.

### BACKGROUND

Modern merchants are susceptible to many forms of fraud, but one form that is particularly pernicious is credit card fraud. With credit card fraud, a fraudster fraudulently uses a credit card or credit card number of another to enter into a transaction for goods or services with a merchant. The merchant provides the goods or services, but since the transaction is with the fraudster the merchant runs the risk of not getting paid. Another form of fraud that is very difficult for merchants, particularly large merchants, to detect, if at all, occurs in the job application process where an applicant has been designated as undesirable in the past—perhaps as a result of having been fired from the employ of the merchant at one location or for failing a criminal background check—fraudulently assumes a different identity and then applies for a job with the same merchant at a different location. In such cases, failure to detect the fraud could result in the rehiring of the fraudster to the detriment of the merchant. If the fraudster has assumed a new identity, background checks based on identity factors such as names or social security numbers become essentially useless. For example consider that case of a large chain store, such as, for example, Walmart. In this case, an employee can be terminated for say theft at one location, but then rehired under a different identity at another location. The employee represents a grave security risk to the company particularly since the employee, being familiar with the company's systems and internal procedures will be able to engage in further conduct injurious to the company.

### SUMMARY

According to a first aspect of the invention there is provided a method, comprising:
(a) maintaining a collection of voice signatures, at least a subset of which is organized to form a list of voice signatures, each belonging to a disqualified candidate;
(b) obtaining a voice sample for a candidate;
(c) comparing the voice sample with the voice signatures in the list; and
(d) if the voice sample matches a signature in the list, then returning a status of disqualified for the candidate.

According to a second aspect of the invention there is provided a method, comprising:
receiving a request form a merchant to perform a fraud detection operation in connection with a credit card transaction by a consumer;
responsive to the request, collecting a voice sample from the consumer;
comparing the collected voice sample with voice signatures of known fraudsters; and
notifying the merchant of a result of the comparing.

Other aspects of the invention will be apparent from the detailed description below.

### BRIEF DESCRIPTION OF THE DRAWINGS

Embodiments of the invention will now be described, by way of example, with reference to the accompanying diagrammatic drawings, in which:

FIG. 1 shows a system within which embodiments of the invention may be practiced;

FIG. 2 shows a client system, in accordance with one embodiment of the invention;

FIG. 3 shows a server system, in accordance with one embodiment of the invention;

FIG. 4 shows a flowchart of operations performed by the client system of FIG. 2, in accordance with one embodiment of the invention;

FIG. 5 shows a flowchart for a screening process performed by the server system of FIG. 3, in accordance with one embodiment of the invention;

FIG. 6 shows a flowchart for an enrolment operation performed by the server system of FIG. 3, in accordance with one embodiment of the invention;

FIG. 7 shows a flowchart operations performed by the server system of FIG. 3 in order to seed a precursor fraudster database, in accordance with one embodiment of the invention;

FIG. 8 shows a flowchart of operations performed by the server system of FIG. 3 in order to cull the precursor fraudster database, in accordance with one embodiment of the invention;

FIG. 9 shows a flowchart of operations performed by the server system of FIG. 3 in order generate a voice signature, in accordance with one embodiment of the invention; and

FIG. 10 shows an example of hardware that might by used to implement any of the client and server systems of the present invention.

### DETAILED DESCRIPTION

In the following description, for purposes of explanation, numerous specific details are set forth in order to provide a thorough understanding of the invention. It will be apparent, however, to one skilled in the art, that the invention may be practiced without these specific details. In other instances, structures and devices are shown at block diagram form only in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the present invention at least reduce losses due to fraudulent transactions, such as for example, credit card transactions by using voice data to identify fraudsters.

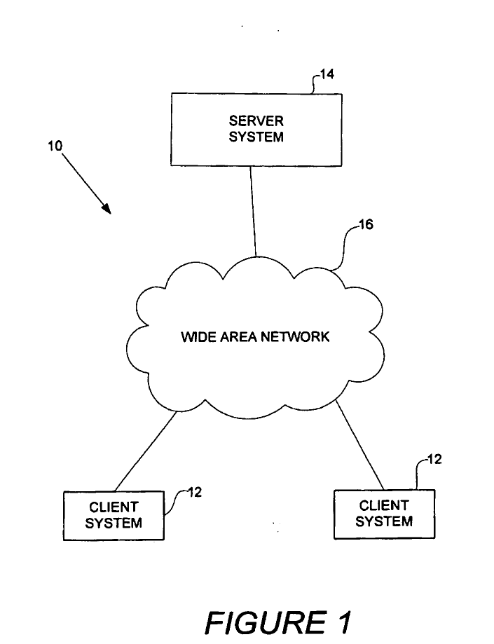

Embodiments of the invention will be described with reference to FIG. 1 of the drawings, which shows a system 10 in accordance with one embodiment of the invention. As will be seen, the system 10 includes a client system 12 which is coupled to a server system 14 via an intermediate Wide Area Network (WAN) 16, which may for example comprise the Internet.

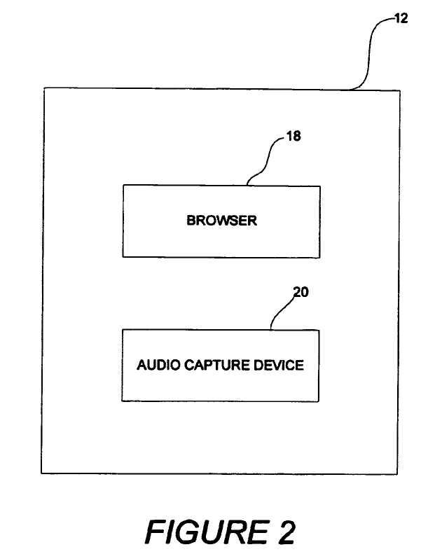

In accordance with embodiments of the invention, the client system 12 may be located on client premises, for example the premises of a merchant. In on embodiment the client system 12 may be a distributed system that includes components that are not all located at a single location, but instead are distributed over multiple locations. As will be seen from FIG. 2 of the drawings, the client system 12 may include software to facilitate communications with the server system 14. In one embodiment the software may include a browser 18 which is an application that facilitates communications via the Wide Area Network (WAN) 16 with the server system 14 using networking protocols such as for example the Hypertext Transfer Protocol (HTTP)/the Internet Protocol (IP),the Simple Object Access Protocol (SOAP), etc. The client system 12 may also include audio capture device 20 may include any device capable of capturing audio such, as for example, a microphone, a telephone, etc. In one embodiment, the audio capture device 20 may be configured to transmit audio to the server system 14 via a secure connection establish using the network 16. An example of such a secure connection may include a Virtual Private Network (VPN) over the public Internet.

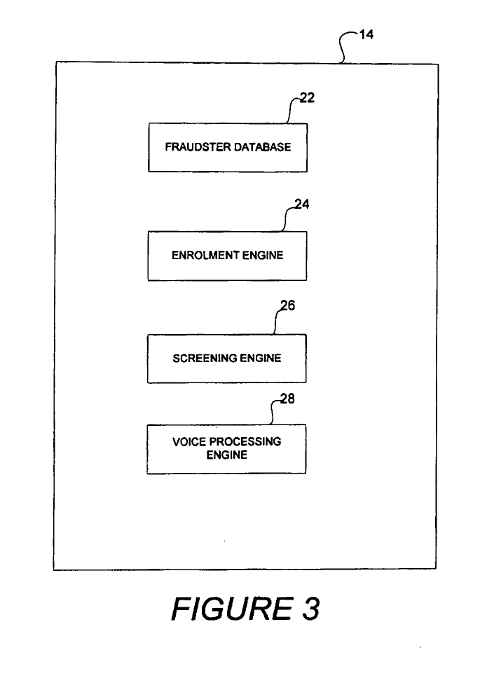

FIG. 3 of the drawings shows a high level block diagram of the server system 14, in accordance with one embodiment of the invention. As will be seen, the server system 14 includes a fraudster database 22, an enrolment engine 24, a screening engine 26, and a voice processing engine 28. Each of the components 22 to 28 may be implemented in hardware or in software or as a combination of both hardware and software. Further, it is to be understood that while the components 22-28 are shown as separate components based on function, in reality some or all the components may be integrated.

The fraudster database 22 includes voice signatures or voice prints of known fraudsters. Essentially, a voice signature or print includes a set of voice characteristics that uniquely identify a person's voice. In one embodiment, each voice signature in the fraudster database 22 is assigned a unique identifier (ID), which in accordance with one embodiment may include a social security number for the fraudster, or a credit card number linked to the fraudster, as will be described later. Briefly, the enrolment engine 24 performs operations necessary to enroll voice signatures of known fraudsters into the fraudster database 22. The screening engine 26 receives requests from the client system 12 to screen a potential fraudster. In response to such requests, the screening engine 26 performs a screening operation and returns a result of the screening operation to the client system 12. In one embodiment, the voice processing engine 28 implements voice processing algorithms that are used by the enrolment engine 24, and the screening engine 26 in the performance of their respective functions, as will be described below.

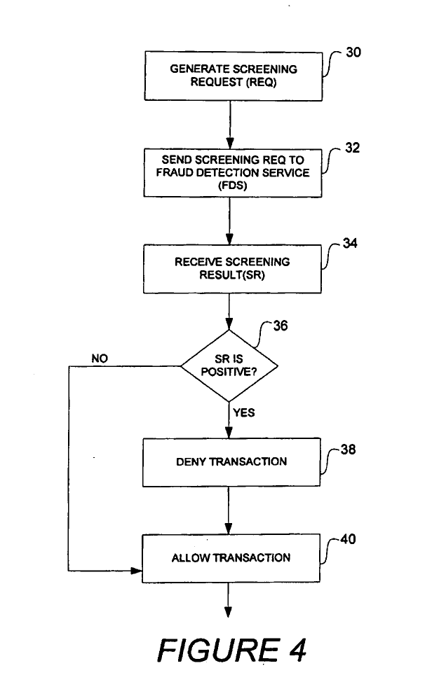

Turning now to FIG. 4 of the drawings, there is shown a flowchart of operations performed by the client system 12, in accordance with one embodiment of the invention. Starting at block 30, the client system generates a screening request (REQ). The screening request (REQ) is to screen a potential fraudster. For example, the client system 12 may be installed on the premises of a retail merchant who may be either a traditional retail merchant with brick and mortar facilities, or an online retail merchant. The retail merchant may be processing a credit card transaction and the screening request generated at 30 is to screen, for example, a purchaser who initiated the credit card transaction so that the credit card transaction may be denied if it turns out that the purchaser is a fraudster. It is to be noted that use of the client system 12 to detect credit card fraud is intended only to be illustrative of how embodiments of the present invention may be used to detect fraud based on voice data. To further the reader's understanding of how embodiments of the present invention may be used to detect fraud, in a second example, the client system 12 may be that of a large nationwide retailer, for example Walmart. In this case, instead of using the client system 12 to detect credit card fraud, the retailer may use the client system 12 as part of a screening process to verify the identity of, say, a job applicant. With regard to the second application, the reader is requested to bear in mind the risks, described in the background section of this application, associated with a retailer in the event of not being able to successfully verify the identity of a job applicant.

Continuing with FIG. 4 of the drawings, at block 32 the client system 12 sends the screening request to the server system 14 which in effect implements a fraud detection service (FDS). At block 34, a result of the screening is received from the server system 14 at block 36, the client system 12 determines if the screening result is positive as will be the case if the job applicant, or the purchaser is a fraudster, in which case at block 38, the transaction (for example a purchasing transaction, or job application) is denied. If at block 36 it is determined that the screening result is negative then control passes to block 40, where the transaction is allowed. Thus, in broad terms, the techniques and systems disclosed herein may be used to disqualify candidates from further participation in a transaction such as a credit card transaction or a job application. In accordance with different embodiments of the invention there may be differences in how a transaction is processed. In some cases the merchant may charge a credit or debit card before the screening result is available. For this case if it turns out that the screening result is positive then the merchant may not ship any goods that may have been purchased. In another embodiment, a credit or debit card is only charged if the screening result is negative. It is important to appreciate at least some, if not all of the operations described with reference to FIG. 4 of the drawings, may be implemented as business logic or rules executing on the client system 12.

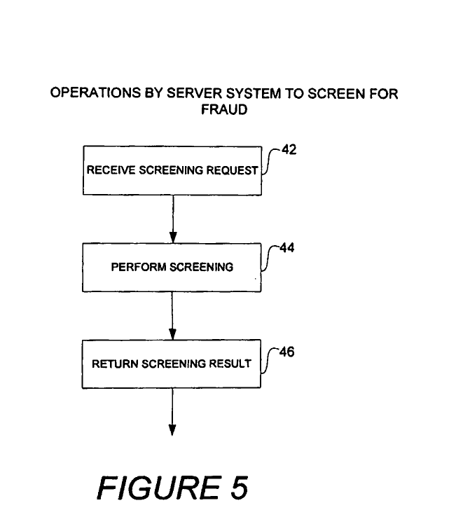

FIG. 5 of the drawing shows a flowchart of operations performed by the server system 14, in accordance with one embodiment of the invention. As will be seen, at block 42, the server system 14 receives the screening request from the client system 12. The screening request is screen a candidate for example a purchaser or a job applicant. At block 44, the server system 14 performs a screening operation based on the request. In one embodiment, the screening operation may include initiating a telephone call to the candidate in order to collect a voice sample for the candidate. The telephone call may be initiated by a live operator or by an automated system. Advantageously, in one embodiment, a series of innocuous questions are posed to the candidate during the telephone call so that the candidate does not suspect that the actual purpose of the call is to collect a voice sample. In one embodiment, the questions may be designed to obtain the candidate's name, credit card number, social security number, etc. In one embodiment the telephone call may be initiated by the candidate. For example, in the case of the candidate being a job applicant, the candidate may be given a telephone number to call. For greater flexibility, in one embodiment screening requests are assigned a unique screening identifier (ID) to be used to identify screening requests made to the server system 14. By using the screening ID, telephone calls can be linked to the appropriate screening request. For example, if a call to a candidate fails for some reason, the screening ID may be provided to the candidate via the merchant so that the when the candidate calls to provide a voice sample, the server system 14 can link the call to a particular screening request based on the screening ID. Once a voice sample for the candidate is obtained, the voice sample is compared to voice signatures in the fraudster database 22. At block 46, the server system 14 returns a screening result to the client system 12, via the intermediate wide area network 16.

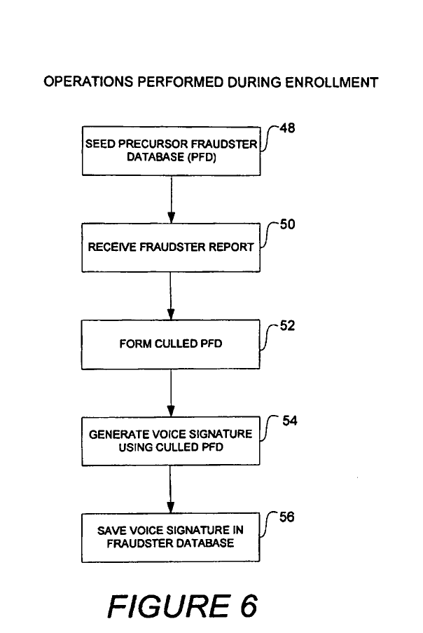

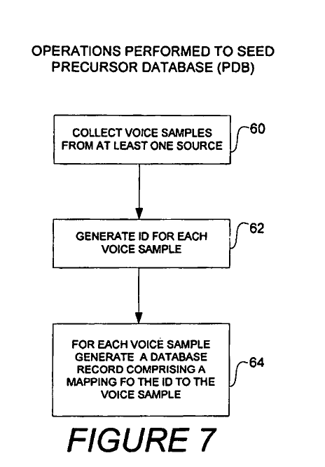

In one embodiment, the enrolment engine 24 of the server system 14 performs an enrolment operation, as shown in the flowchart of FIG. 6. Turning to FIG. 6, the enrolment operation includes a block 48 where a precursor fraudster database (PFD) is seeded or populated. FIG. 7 of the drawings shows a flowchart of operations performed at block 48 to seed the precursor database in accordance with one embodiment of the invention. As will be seen, at block 60, voice samples from at least one source, for example a merchant or vendor, are collected. The voice samples are collected without regard as to whether they are fraudulent or not. In one embodiment, collecting the voice samples includes operations similar to the operations of block 44 described above where a call is initiated to the candidate or the candidate is asked to call. At block 62, a unique identifier (ID) is generated for each voice sample. The unique identifier (ID) may be generated using speech recognition techniques, human transcription, or by a combination of speech recognition techniques and human transcription. In one embodiment, the unique identifier (ID) may be a credit card number embedded in the voice sample. At block 64, a database record is generated for each voice sample. The database record comprises a mapping of the unit ID to the voice sample. It will be appreciated, that as a result of the seeding operation performed at block 48, the precursor fraudster database (PFD) will include a large number of voice samples, without any information as to which of these samples belong to fraudsters. Thus, one goal of the enrollment operation performed by the enrollment engine 24 is to form a subset of voice samples from the precursor fraudster database (PFD), wherein the subset only contains voice samples known to belong to fraudsters. For ease of reference, such a subset of voice samples will be referred to as the “culled precursor fraudster database (PFD)”. Continuing with FIG. 6, at block 50, a fraudster report is received from a merchant. In one embodiment, the fraudster report may be received from the client system 12 via the wide area network 16. In essence, the fraudster report includes information, such as, for example, credit card numbers known to have been used fraudulently, or social security numbers associated with instances of fraud, etc. In one embodiment, the fraudster report is received periodically from the merchant.

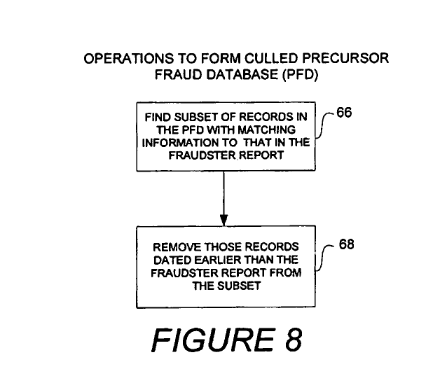

At block 52, the culled precursor fraudster database (PFD) is generated or formed. The particular operations performed in order to form the culled precursor database (PFD), in accordance with one embodiment, is shown in the flowchart of FIG. 8. As will be seen, at block 66 the enrollment engine 24 finds a subset of records in the precursor database (PFD) with matching information to that in the fraudster report. For example, consider the case where the voice samples in the precursor fraudster database (PFD) contains information relating to a credit card transaction. In this case the operations at block 66, include searching the precursor fraudster database (PFD) for those voice samples that include a credit card number that matches a credit card number appearing in the fraudster report.

At block 68, the subset of records determined at block 66, is further reduced by removing those records dated earlier than the fraudster report from the subset. The operation at block 68 is performed so that voice samples belonging to non-fraudsters do not form part of the subset or culled precursor database (PFD). By virtue of the operations performed in the flowchart of FIG. 8, it will be appreciated that the culled PFD includes only the voice samples of known fraudsters.

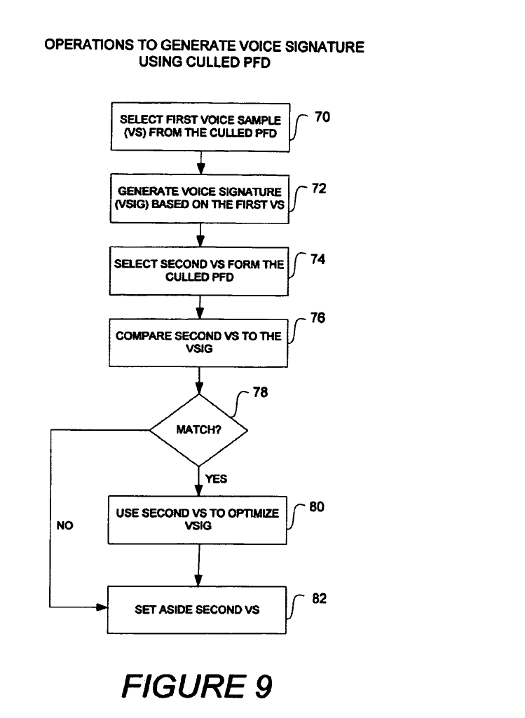

Continuing with FIG. 6, at block 54, voice signatures are generated using the culled PFD. Turning now to FIG. 9 of the drawings, there is shown a flowchart of operations performed, in accordance with one embodiment of the invention, in order to generate the voice signatures at block 54. As will be seen, at block 90, a first voice sample (VS) from the culled PFD is selected. In one embodiment, this is a random selection. At block 92, using the voice processing engine 28, a voice signature (VSIG) based on the first voice sample is generated. At block 94, a second voice sample from the culled PFD is selected. Thereafter, at block 96, the second voice sample is compared to the voice signature (VSIG) that was generated based on the first voice signature.

At block 98, if the second voice sample matches the voice signature then control passes to block 100, otherwise control passes to block 102. At block 100, the second voice sample is used to train or optimize the voice signature. At block 102, the second voice sample is set aside, in other words it is not considered in the training of the voice signature. In one embodiment, the operations 90 to 102 are performed until a predefined number of fraudulent voice signatures are generated. In one embodiment, the voice samples that were set aside at block 102 are considered to form a separate subset and the operations 90 to 102 are performed on this separate subset. Thus, several voice signatures may emerge as a result of the repeated performance of the steps 90 to 102, of FIG. 9.

Continuing with FIG. 6 of the drawings, at block 56, the voice signatures that were generated as per the flowchart of FIG. 9 are saved in a fraudster database.

It will be appreciated that once the fraudster database 22 is constructed in accordance with the above described techniques, performing the screening operation at block 44 can be achieved by comparing against the voice signatures in the fraudster database in order to find a match, which would be indicative of a fraudster.

The foregoing described how the fraudster report may be used to disqualify a candidate attempting to complete a transaction such as a credit card transaction or purchase. It is to be appreciated that the techniques described herein may be used to disqualify candidates from other types of transaction such a, for example, a debit card transaction.

For the employment verification case the fraudster report is generated by an employer, who designates disqualified or undesirable candidates using a unique identifier for the candidate, such as for example, a social security number for the candidate. Candidates may become undesirable because of, for example, a failed background check or because they were fired.

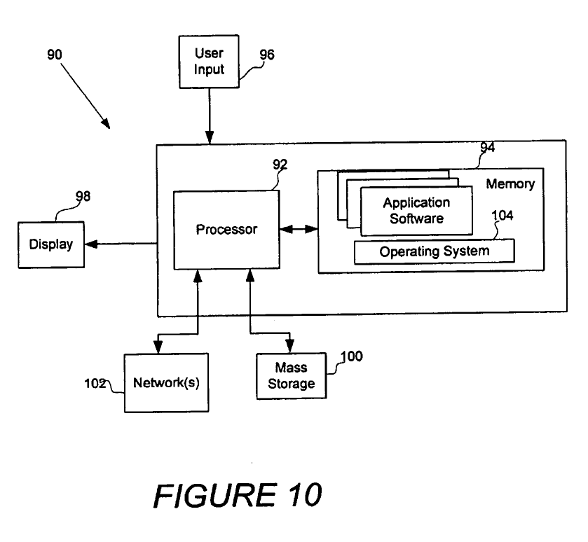

The client system 12 and the server system 14 have, thus far, been described in terms of their respective functions. By way of example, each of the client and server systems of the present invention may be implemented using the hardware 90 of FIG. 10. The hardware 90 typically includes at least one processor 92 coupled to a memory 94. The processor 92 may represent one or more processors (e.g., microprocessors), and the memory 94 may represent random access memory (RAM) devices comprising a main storage of the system 90, as well as any supplemental levels of memory e.g., cache memories, non-volatile or back-up memories (e.g. programmable or flash memories), read-only memories, etc. In addition, the memory 94 may be considered to include memory storage physically located elsewhere in the system 90, e.g. any cache memory in the processor 92, as well as any storage capacity used as a virtual memory, e.g., as stored on a mass storage device 100.

The system 90 also typically receives a number of inputs and outputs for communicating information externally. For interface with a user or operator, the system 90 may include one or more user input devices 96 (e.g., a keyboard, a mouse, etc.) and a display 98 (e.g., a Liquid Crystal Display (LCD) panel).

For additional storage, the system 90 may also include one or more mass storage devices 100, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 90 may include an interface with one or more networks 102 (e.g., a local area network (LAN), a wide area network (WAN), a wireless network, and/or the Internet among others) to permit the communication of information with other computers coupled to the networks. It should be appreciated that the system 90 typically includes suitable analog and/or digital interfaces between the processor 92 and each of the components 94, 96, 98 and 102 as is well known in the art.

The system 90 operates under the control of an operating system 104, and executes various computer software applications, components, programs, objects, modules, etc. to perform the respective functions of the client and server systems of the present invention. Moreover, various applications, components, programs, objects, etc. may also execute on one or more processors in another computer coupled to the system 90 via a network 102, e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

One advantage of the techniques and systems described herein is that fraud detection is base on a fraudster's voice, which being biometric in nature is linked to the fraudster. This is in contrast with techniques that use parametric information such, for example, lists of stolen credit cards to control fraud. It will be appreciated that the embodiments of the present invention will enable fraud detection even in cases where the theft or loss of a credit card had not been reported.

What is claimed is:

1. A method, comprising:
(a) maintaining a collection of voice signatures, at least a subset of which is organized to form a list of voice signatures, each belonging to a disqualified candidate;
(b) obtaining a voice sample for a candidate;
(c) comparing the voice sample with the voice signatures in the list; and
(d) if the voice sample matches a signature in the list, then returning a status of disqualified for the candidate.

2. The method of claim 1, implemented as part of a system to at least reduce credit card fraud.

3. The method of claim 1, implemented as part of a screening process, further comprising rejecting an application by a disqualified candidate.

4. The method of claim 1, wherein the application comprises an application for employment.

5. The method of claim 1, wherein obtaining the voice sample comprises recording the candidate's voice during a telephone call with the candidate.

6. The method of claim 5, further comprising initiating the telephone call to the candidate and posing a series of questions to the candidate, recording the candidate's voice then comprising recording responses to the series of questions.

7. The method of claim 1, wherein the telephone call is initiated by the candidate, recording the voice sample then comprising recording responses by the candidate to predefined questions.

8. A method, comprising:
receiving a request form a merchant to perform a fraud detection operation in connection with a credit card transaction by a consumer;
responsive to the request, collecting a voice sample from the consumer;
comparing the collected voice sample with voice signatures of known fraudsters; and
notifying the merchant of a result of the comparing.

9. The method of claim 8, wherein the merchant declines to proceed with the credit card transaction if the result of the comparing is a match.

10. The method of claim 8, further comprising building a fraudster database comprising the voice signatures of known fraudsters, wherein the comparing is performed based on voice signatures from the fraudster database.

11. The method of claim 9, wherein building the fraudster database comprises collecting voice samples for a plurality of consumers and storing the voice samples in a precursor database.

12. The method, of claim 10, wherein building the fraudster database comprises receiving periodic reports from the merchant identifying a credit card number associated with a fraudulent transaction, and responsive to said receiving, extracting a subset of voice samples from the precursor database that include the credit card number.

13. The method of claim 12, wherein building the fraudster database comprises constructing a voice signature for a fraudster based on the subset of voice samples.

14. The method of claim 13, wherein constructing the voice signature comprises selecting a first voice sample from the subset of voice samples and constructing the voice signature based on analysis of the first voice sample.

15. The method of claim 14, wherein constructing the voice signature further comprises selecting a second voice sample from the subset of voice samples; and comparing the second voice sample with the voice signature.

16. The method of claim 15, wherein if the comparing results in a match then using then optimizing the voice signature based on analysis of the second voice.

17. The method of claim 15, wherein selecting the second voice sample, comparing the second voice sample, and optimizing the voice signature is repeated until each voice sample from the subset of voice samples, other than the first voice sample is selected.

18. The method of claim 8, wherein the request is received at the time of the credit card transaction, and the notification is provided in real-time so that the merchant can approve or decline the credit card transaction.

19. The method of claim 8, wherein collecting the voice sample, comprises initiating a telephone call to the consumer, and posing a series of questions to the consumer, the responses to the question then forming the voice sample.
